(19) United States
(12) Patent Application Publication
(10) Pub. No.: US 2010/0319650 A1
(43) Pub. Date: Dec. 23, 2010

(54) FUNCTIONALLY GRADED POWDER METAL COMPONENTS

(76) Inventors: Delbert P. Clozza, Plymouth, MI (US); Henry J. Knott, Ypsilanti, MI (US); Leonard Leech, Walled Lake, MI (US); Raymond K. Williams, Saline, MI (US)

Correspondence Address: QUARLES & BRADY LLP, 411 E. WISCONSIN AVENUE, SUITE 2040, MILWAUKEE, WI, 53202-4497, US

(21) Appl. No.: 12/667,413

(22) PCT Filed: Jul. 11, 2008
(86) PCT No.: PCT/US08/69767

§ 371 Date: Dec. 31, 2009

Related U.S. Application Data
(60) Provisional application No. 60/959,052, filed on Jul. 11, 2007.

(51) Int. Cl. F02B 75/32; C21D 6/00

(52) U.S. Cl. 123/197.3; 148/660

(57) ABSTRACT

The invention provides a method of manufacturing a ferrous monolithic component and the component that results from the method. The method of the invention utilizes selective rapid cooling of the portion of the component that is desired to have increased strength and selective controlled cooling of the portion or portions which are desired to be more machinable. The controlled cooling may include cooling, re-heating and re-cooling. The result is a component with local high strength in the rapidly cooled zones and locally altered metallurgical properties to improve machinability in the more slowly cooled zones.

### CROSS-REFERENCE TO RELATED APPLICATION

This application claims the benefit of U.S. Provisional Patent Application Ser. No. 60/959,052 entitled “Functionally Graded Powder Metal Components”, filed on Jul. 11, 2007, which is hereby incorporated by reference in its entirety.

### STATEMENT CONCERNING FEDERALLY SPONSORED RESEARCH OR DEVELOPMENT

Not applicable.

### FIELD OF THE INVENTION

This invention relates to sintered and forged powder metal (PM) components. In particular, this invention relates to components made of a single alloy, but that have different characteristics in different parts of the component.

### BACKGROUND OF THE INVENTION

Most powder metal components are composed of a single ferrous material throughout. However, many powder metal components have a number of sections, each of which have different, and sometimes conflicting, material requirements (e.g., hardness, strength, machinability, and the like). To meet all of the different requirements with a single ferrous material often means that some or all of the sections will have compromised material properties, so that all of the sections can meet their particular minimum requirement.

One example of a powder metal component with varying requirements is an automotive connecting rod. One of the most stressed components in an internal combustion engine, the automotive connecting rod has a number of sections, some of the sections having different requirements than others. As can be seen in FIG. 1, an automotive connecting rod 10 includes an I-beam region (Zone A), a piston pin end (Zone B), and a crank shaft end (Zone C).

In the I-beam region, it is desirable to have the lowest possible mass with the highest possible material strength. These requirements are necessary to improve economy and to perform the intended function of transferring linear motion and rotary motion while resisting buckling and stretching.

On the other hand, the piston pin end and the crank shaft end must be highly machinable. The piston pin end bore and crank shaft end bore are each machined to achieve a tight tolerance to ensure a proper fit and function. On the side of the crank shaft end bore (Zone D), bolt holes must be drilled, reamed and tapped in the bolt boss zones for bolts that hold the end of the connecting rod on after it is fractured away from the remainder of the connecting rod. In high volume production, it is of great benefit if these zones can be machined economically.

However, an increase in the strength resulting from, for example, a heat treating operation, results in a reduction in machinability. Given this trade-off, a balance must be struck between strength and machinability. A connecting rod made with a strong beam section will be difficult to machine. Conversely, a connecting rod that is easily machined may be more susceptible to failure in the I-beam section. Achieving the proper balance between strength and machinability is difficult to achieve using convention manufacturing methods and usually results in at least one of the zones having less than ideal material properties.

Thus, a need exists for an improved component that has different properties in the same integral monolithic structure.

### SUMMARY OF THE INVENTION

The invention provides a method of manufacturing a ferrous monolithic component and the component that results from the method. In the case of a connecting rod, for example, the method yields a connecting rod with different desired properties in differing portions of the connecting rod, even though the same material is used throughout the entire connecting rod.

A method of the invention utilizes selective rapid cooling of the portion of the component that is desired to have increased strength and selective controlled cooling of the portion or portions which are desired to be more machinable. The controlled cooling may include cooling, re-heating and re-cooling. The result is a component with local high strength in the rapidly cooled zones and locally altered metallurgical properties to improve machinability in the more slowly cooled zones.

In the case of a connecting rod, selective rapid cooling is applied to the I-beam zone and selective controlled cooling is applied to the pin and crank regions, which may be re-heated and re-cooled. The result is a connecting rod with local high strength in the I-beam zone and more machinable pin and crank ends, due to altered metallurgical properties at those ends relative to the I-beam zone.

The selective rapid cooling may be accomplished in several ways. For example, heat transfer may be accomplished using convection techniques such as directional air knives, or heat transfer may be by conduction using a suitable heat sink in an appropriate location. Selective re-heating with controlled re-cooling of select local regions may be accomplished, for example, with rapid local induction heating of the selected region along with controlled local cooling to achieve the desired properties. The heating may be carried out such that the heated microstructure may be fully austenitic or may consist of a mixture of austenite and ferrite. The heating/controlled cooling is carried out such that the resulting select regions have significantly altered metallurgical properties than that of the I-beam, specifically lower hardness, lower strength and a different microstructure. In particular, the I-beam and transitional zones of a connecting rod may have the core hardness and strength increased by creating a higher percentage of fine pearlite which in a typical application is 5-7% in the bolt boss zone and higher in the I-beam zone. At the same time, it is desirable to slow cool the ears of the bolt bosses to obtain a more favorable structure for drilling and tapping by increasing the pearlitic lamellae spacing. In addition, the ears of the bolt bosses and/or the I-beam zone could be cooled to create a phase transformation from austenite to bainite or martensite or both, or both in combination with fine pearlite. These are stronger phases, but more difficult to machine.

The material of the component can be any ferrous PM material. In one application, connecting rods were made from a 2% copper 11C60 PM material. From a starting temperature of 1700° F. (the temperature at forging), the beam, crank transition and pin transition regions were cooled at a rate to achieve a temperature of 1240° F. or less in 30 seconds. Thereafter, the cooling rate was maintained to achieve a temperature of 1200° F. or less after 50 seconds (measured from the same initiation point as the original 30 seconds). In the bolt boss ear region and the bore regions, the rate of cooling was controlled to achieve a temperature of 1250° F. or higher after a minimum of 180 seconds. It should be appreciated that the times and temperatures for the heat treatment process in each of the zones may be different for different alloys and for connecting rods having a different resultant properties.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a connecting rod illustrating different zones of the connecting rod;

FIG. 2 is a plan view of a connecting rod indicating three different zones or portions;

FIG. 3 is a graph of time versus temperature to illustrate cooling at different connecting rod locations in one particular connecting rod material;

FIG. 4A is a schematic view of a connecting rod in cross-section with preheated masses inserted into the bores;

FIG. 4B is a view from the top of one of the ends of the connecting rod and masses shown in FIG. 4A illustrating insulation on the heated mass;

FIG. 5A is a top view of a conveying system for controlled cooling of a series of connecting rods;

FIG. 5B is a side schematic view of the conveying system of FIG. 5A;

FIG. 6A is a view like FIG. 5A but showing another station for reheating the ends of the connecting rods; and

FIG. 6B is a side view of the portion of the conveying system shown in FIG. 6A.

### DETAILED DESCRIPTION OF THE PREFERRED EMBODIMENT

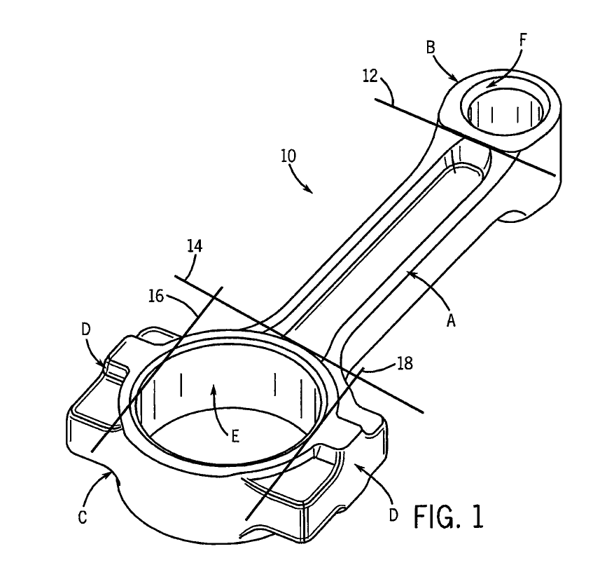

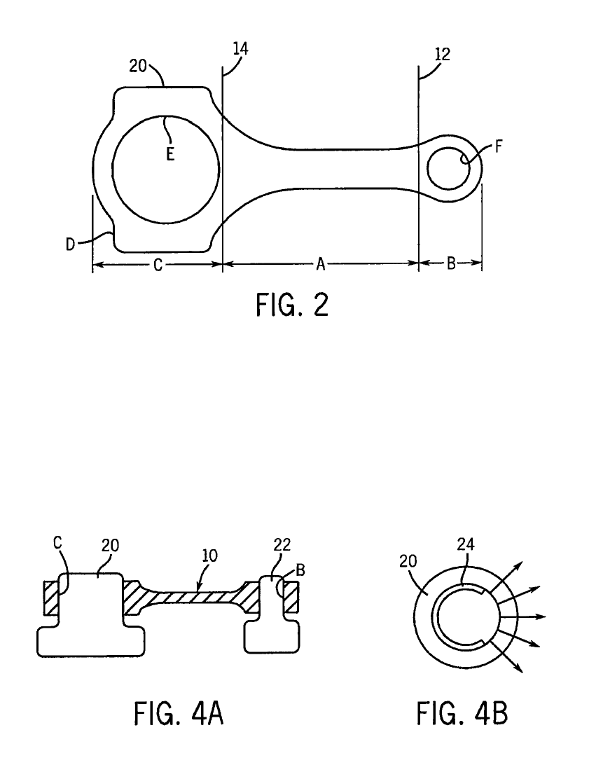

FIGS. 1 and 2 illustrate a component, in particular a connecting rod 10, having a wrist pin end zone B, a crank end zone C, and an I-beam zone A between the two end zones B and C. A line 12 separates the I-beam zone A from the wrist pin end zone B and a line 14 separates the crank end zone C from the I-beam zone A. The crank end zone C includes two bolt boss ears D. Lines 16 and 18 demarcate the two bolt boss ears D from the remainder of the crank end zone C of the connecting rod 10. The crank end zone C includes a crank bore E and the wrist pin end zone B includes a bore F. As stated above, the bores E and F and the bolt boss ears D are machined after the connecting rod 10 is forged. The connecting rod 10 is subsequently processed as described below.

A typical method of making the connecting rod using powder metal would be to first compact the powder metal alloy into the shape of the connecting rod, then sinter the compacted component, forge it, and selectively rapid cool and/or control cool portions of it at different rates as will be described below in detail, deburr the component to remove flash, selectively re-heat in combination with controlled re-cooling of portions of the component if necessary, shot peen the component, face grind the component, mark the component, machine out rough bores in the component, machine the bolt holes in the ears D, fracture the bearing cap portion off of end C, install the bolts, face grind the component and then finish bore the crank end bore, and the wrist pin bore, if necessary. Some of these steps may be excluded, or other manufacturing process steps may be included, or the alloy modified, as necessary.

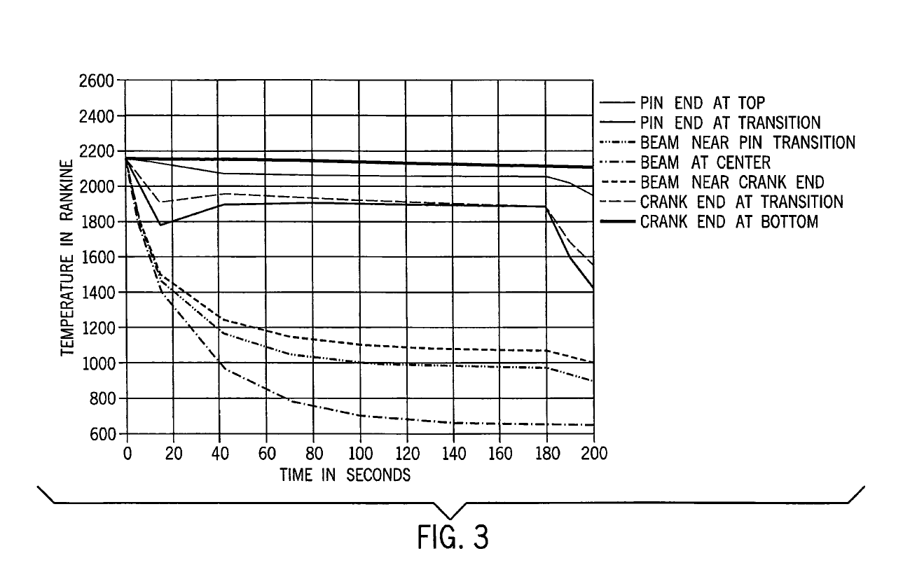

Referring now to FIG. 3, a time-temperature graph is shown for the cooling of various locations within a connecting rod made from a single powder metal alloy of 11C60 material with a 2% copper additive. Notably, the I-beam zone A, represented by the bottom three graph lines in FIG. 3, cools more rapidly than the end zones B and C, represented by the top four lines in FIG. 3. Note that the axis in FIG. 3 is in degrees Rankine, which can be converted to degrees Fahrenheit by subtracting approximately 460 degrees from the Rankine temperature.

The rapid cooling of the I-beam zone A results in higher hardness and higher strength, but lower machinability. Cooling the ends B and C more slowly results in lower hardness and strength, but higher machinability. The I-beam zone A, including the indicated portions of the transition zones, is preferably rapidly cooled to form fine pearlite, bainite, martensite or a mixture thereof. It should be appreciated that the time and temperature parameters for the selective quench necessary to form martensite will depend on the alloy being used.

For 11C60 with a 2% copper additive, this rapid cooling means dropping the temperature to 1240° F. (1700 R) or below in approximately 30 seconds. This temperature (at or slightly below the martensite transformation temperature) is maintained for another 20 seconds (total of 50 seconds from time zero). 11C60 includes iron, copper 1.8-2.2 wt. %, manganese sulfide 0.3-0.5 wt. %, manganese 0.10-0.25 wt. %, and carbon (as graphite approximately 0.60 wt. %).

For the ends, the cooling is controlled such that the temperature remains above the material's martensite transition temperature for a sufficient length of time to prevent the formation of martensite at the ends. In the case of the 11C60 material, this means the ends are maintained at a temperature above 1250° F. (1710 R) for a minimum 180 seconds. By holding the ends at this temperature, carbon is provided with sufficient time to diffuse to avoid the formation of martensite during cooling.

Referring to FIGS. 4A and 4B, one way of achieving differential cooling between the zones of the connecting rod 10 is illustrated. In this example, preheated masses 20 and 22 are placed inside and in mating contact with the bores in the ends of the connecting rod to keep the ends above the martensite transformation temperature for the necessary length of time, while rapidly cooling the I-beam zone A. In the case of the 11C60 material, the preheated masses 20 and 22 keep the ends at or above 1250° F. (1710 R) for at least 180 seconds from time zero, while the I-beam is rapidly cooled to below 1240° F. (1700 R) in 30 seconds and below 1200° F. (1660 R) after 50 seconds from time zero by, for example, being placed in a cooling atmosphere. As illustrated in FIG. 4B, insulation 24 can be provided as needed between bores of the connecting rod and the mass 20 to selectively insulate the mass 20 from the bore so as to control the heat input to that end of the connecting rod 10.

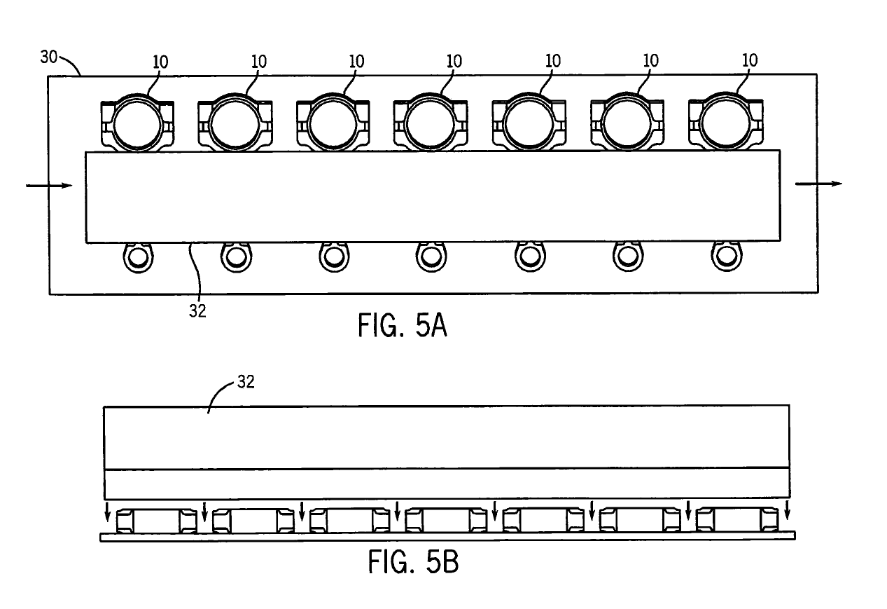

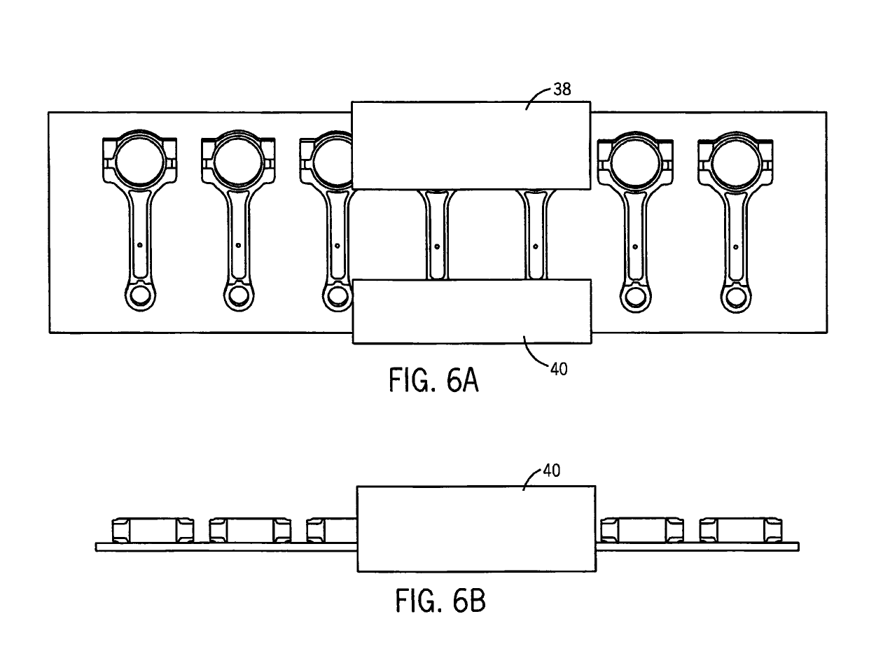

Alternatively, using heated masses on the ends may not be necessary if a sufficient distinction in cooling between the ends and the I-beam can be made with the conveying system illustrated in FIGS. 5A and 5B. In this system, connecting rods 10 are lined up along a conveyor belt 30 and passed under an air knife cooler 32 that passes cooling air or another cooling medium over only I-beam zone A, while end zones B and C are in ambient atmosphere with no accelerated cooling. Alternatively, and referring now to FIGS. 6A and 6B, induction heaters 38 and 40 can be used over only the ends B and C. The cooler 32 may be used simultaneously with the induction heaters 38 and 40. In addition, the induction heaters 38 and 40 can be used to re-heat the ends B and C after the connecting rods have been fully cooled to ambient, to a starting temperature of 1700° F. (2160 R) or higher and thereafter the cooling of the ends controlled to produce cooling to 1250° F. (1710 R) or greater after greater than 180 seconds.

The material of the connecting rods 10 may be any suitable material that responds to heat treatment. For example, for making powder metal connecting rods, a 1% to 3% copper 11C60 powder metal material can be used.

A preferred embodiment of the invention has been described in considerable detail. Many modifications and variations to the preferred embodiment described will be apparent to a person of ordinary skill in the art. Therefore, the invention should not be limited to the embodiment described.

We claim:

1. A component comprising a ferrous powder metal material that is monolithic throughout the component, the component having at least two zones, one of the zones being machined and the other zone not being machined and wherein the machined zone is cooled more slowly than the unmachined zone so that the unmachined zone has a higher percentage than the machined zone of a microstructure selected from the group consisting of one or more of fine pearlite, bainite and martensite.

2. A component as in claim 1, wherein the higher percentage in the unmachined zone is produced by applying cooling to the unmachined zone at a faster rate than the machined zone.

3. A component as in claim 1, wherein the entire component is made of the same powder metal material.

4. A component as in claim 1, wherein the component is a connecting rod for an internal combustion engine.

5. A component as in claim 4, wherein the ends of the connecting rod include machined zones and a middle zone of the connecting rod that connects the ends is an unmachined zone.

6. A component as in claim 5, wherein the middle zone of the connecting rod has greater strength than the ends of the connecting rod.

7. A component as in claim 5, wherein the component is composed of an 11C60 powder metal material with 2% copper added.

8. A component as in claim 7, wherein the middle zone is cooled from at least 1700° F. to 1240° F. or less in 30 seconds or less.

9. A component as in claim 8, wherein the middle zone is cooled to 1200° F. or less after an additional 20 seconds.

10. A component as in claim 7, wherein the ends of the connecting rod are cooled at a rate to achieve a temperature of 1250° F. or higher from a temperature of at least 1700° F. after at least 180 seconds.

11. A component as in claim 5, wherein the middle zone of the connecting rod is quenched from a forging temperature at a rate to form fine pearlite, bainite, martensite, or a mixture thereof in the middle zone.

12. A component as in claim 11, wherein the middle zone of the connecting rod is maintained at a temperature just below the martensite transformation temperature after quenching for a period of time.

13. A component as in claim 11, wherein the ends of the connecting rod are controllably cooled at a rate to avoid the formation of fine pearlite, bainite, martensite, or a mixture thereof in the ends.

14. A method of making the component of claim 1, including the step of re-heating the component and cooling the two zones of the component at different rates to achieve a higher machinability in the machinable zone and a higher strength in the other zone.

15. A method of selectively heat treating a component made from a single powder metal material comprising:
heating the component having at least two zones;
selectively cooling the zones of the component including rapidly cooling at least one zone of the component and slowly cooling at least one zone of the component.

16. The method of claim 15, wherein the step of heating the component includes raising a temperature of the component to a forging temperature.

17. The method of claim 15, wherein rapidly cooling includes quenching one zone of the component to at or below a martensite transformation temperature and slowly cooling the other zone of the component includes maintaining the zone at a temperature above the martensite transformation temperature for a sufficient period of time to inhibit the formation of martensite.

18. The method of claim 15, wherein the zone of the component that is slowly cooled exhibits improved machinability over the zone of the component that is rapidly cooled.

19. The method of claim 15, further comprising the step of re-heating the component and cooling the two zones of the component at different rates to achieve a higher machinability in the zone that is more slowly cooled and a higher strength in the zone that is rapidly cooled.

20. The method of claim 15, wherein the component is a connecting rod having two end zones and an I-beam zone formed therebetween.
